(19) United States
(12) Patent Application Publication
(10) Pub. No.: US 2009/0063322 A1
(43) Pub. Date: Mar. 5, 2009

(54) SYSTEM AND METHOD FOR REAL-TIME AUTOMATED SECURITIES TRADING

(76) Inventor: Richard Billingsley, (US)

Correspondence Address: KALI LAW GROUP, P. C, P.O. BOX 60187, SUNNYVALE, CA, 94088-0187, US

(21) Appl. No.: 11/845,399

(22) Filed: Aug. 27, 2007

(51) Int. Cl. G06Q 40/00

(52) U.S. Cl. 705/37

(57) ABSTRACT

Methods for making real-time automated security trades are presented, the methods including: receiving historical market data related to a selected security; receiving affective data related to the selected security; performing an analysis on the historical market data and the affective data to produce a set of causally related input parameters, the set of causally related input parameters configured to provide a basis for determining whether to trade the selected security; receiving current market data related to the selected security; applying the current market data to the set of causally related input parameters; and automatically trading the selected security based on the applying. In some embodiments, methods further include: incorporating the current market data with the historical market data; and returning to the performing the analysis.

### BACKGROUND

The present invention relates to securities trading. In particular, the present invention relates to methods for making automated stock trades utilizing analytic data in an iterative manner.

With the advent of online trading, completing a stock trade has become relatively commonplace. Online trading allows professional and non-professional stock traders alike to access markets quickly and efficiently. In determining whether to make a trade, stock traders may utilize any number of strategies. For example, trend following, range trading, scalping, rebate trading, and news playing are basic strategies for day traders—a particular type of stock trader. In each of these strategies, a trader may formulate a strategy and then execute a number of trades in alignment with that strategy.

At least one drawback in employing a particular strategy or analytic model in conventional solutions is the inability for the model to employ separately relevant data. For example, a trend following strategy assumes that financial instruments (i.e. stocks), which have been rising will continue to rise and financial instruments which have been falling will continue to fall. Decisions to execute a trade based on a trend are, by definition, two-dimensional in that only a rise or a fall over time is utilized as a predictor of future outcomes. Trend following strategies fall short as an analyst may not know or perceive when a trend will reverse due to factors that may not initially appear to be related to the trend. Without the ability to apply additional heuristics to a given strategy, risk may not be readily quantifiable.

In addition, because strategies may not have multi-dimensional aspects, automated trading solutions may not provide optimal results. For example, it is not difficult to imagine a trading scenario where buy and sell prices oscillate with sufficient frequency to leave an automated system buying high and selling low (in direct contradiction to the maxim, “buy low, sell high”). Thus, in many conventional systems, a trade execution requires direct user input before a transaction is completed. Direct user input may help eliminate faulty trading scenarios for specific market situations. However, this requirement may introduce lag which may adversely effect or nullify a selected strategy.

It may be desirable to provide methods for automatically trading securities utilizing on-going market data. As such, method for real-time automated securities trading are presenting herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Methods for making real-time automated security trades are presented, the methods including: receiving historical market data related to a selected security; receiving affective data related to the selected security; performing an analysis on the historical market data and the affective data to produce a set of causally related input parameters, the set of causally related input parameters configured to provide a basis for determining whether to trade the selected security; receiving current market data related to the selected security; applying the current market data to the set of causally related input parameters; and automatically trading the selected security based on the applying. In some embodiments, methods further include: incorporating the current market data with the historical market data; and returning to the performing the analysis. In some embodiments, the historical market data includes: historical security price, historical security index, historical price earnings, historical volume traded, historical first best buy and sell price, historical second best buy and sell price, historical third best buy and sell price, historical dividends, historical news analysis statistics, historical announcement analysis statistics, historical related securities, historical related indices, historical unrelated securities, and historical unrelated indices. In some embodiments, the affective data includes: historical trends, volume trends, performance trends, and trends related to functional analyses of the historical market data. In some embodiments, the analysis includes: portfolio holdings analysis, research report analysis, fundamental information analysis, global statistical analysis, and regional statistical analysis.

In some embodiments, the set of casually related input parameters include: a lower bound quantity; an upper bound quantity; a highest buy price; and a lowest sell price. In some embodiments, the current market data includes: a current buy price, a current sell price, a last traded price, a regional order queue buy price for an individual exchange, a regional order queue sell price for an individual exchange, a global order queue buy price for an individual exchange, a global order queue sell price for an individual exchange, a previous-day close reference price, and a last traded volume. In some embodiments, automatically trading the selected security includes: determining whether a quantity held is less than the lower bound quantity; if the quantity held is less than the lower bound quantity, determining whether the current buy price is lower than the highest buy price; if the current buy price is lower than the highest buy price, executing a buy trade; else determining whether the quantity held is greater than the upper bound quantity; if the quantity held is greater than the upper bound quantity, determining whether the current sell price is higher than the lowest sell price; and if the current sell price is higher than the lowest sell price, executing a sell trade.

In some embodiments, automatically trading the selected security includes: determining whether a quantity held is less than the lower bound quantity; if the quantity held is less than the lower bound quantity, determining whether the current buy price is lower than the lowest sell price; if the current buy price is lower than the lowest sell price, executing a buy trade; else determining whether the quantity held is greater than the upper bound quantity; if the quantity held is greater than the upper bound quantity, determining whether the current sell price is higher than the highest buy price; and if the current sell price is higher than the highest buy price, executing a sell trade.

In some embodiments, automatically trading the selected security includes: determining whether a quantity held is greater than the upper bound quantity; if the quantity held is greater than the upper bound quantity, determining whether the current sell price is higher than the lowest sell price; if the current sell price is higher than the lowest sell price, executing a sell trade; else determining whether the quantity held is less than the lower bound quantity; if the quantity held is less than the lower bound quantity, determining whether the current buy price is lower than the highest buy price; and if the current buy price is lower than the highest buy price, executing a buy trade, wherein the upper bound quantity is inverted with respect to the lower bound quantity and the highest buy price is inverted with respect to the lowest sell price. In some embodiments, the buy trade includes: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at VWAP trade. In some embodiments, the sell trade includes: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

In other embodiments, systems for making real-time automated security trades are presented, the systems including: a historical market data module configured for receiving historical market data related to a selected security; an affective data module configured for receiving affective data related to the selected security; a market analytics module configured for performing an analysis on the historical market data and the affective data to produce a set of causally related input parameters, the set of causally related input parameters configured to provide a basis for determining whether to trade the selected security; a current market data module configured for receiving current market data related to the selected security; and an automated trading module configured for automatically creating a plurality of trade decisions for the selected security based on the set of causally related input parameters; and a market access module for conveying the plurality of trade decisions to a securities broker. In some embodiments, the analytics module is further configured to apply the current market data to the set of causally related input parameters and to incorporate the current market data with the historical market data.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a securities trading system in accordance with embodiments of the present invention;

FIG. 2 is an illustrative flowchart of methods for utilizing a securities trading system in accordance with embodiments of the present invention;

FIG. 3 is an illustrative representation of a graph illustrating how operational parameters may be utilized for trading securities in a standard mode in accordance with embodiments of the present invention;

FIG. 4 is an illustrative flowchart of methods for trading securities in a standard mode in accordance with embodiments of the present invention;

FIG. 5 is an illustrative representation of a graph illustrating how causally related input parameters may be utilized for trading securities in a safe mode in accordance with embodiments of the present invention;

FIG. 6 is an illustrative flowchart of methods for trading securities in a safe mode in accordance with embodiments of the present invention;

FIG. 7 is an illustrative representation of a graph illustrating how causally related input parameters may be utilized for trading securities in a market making mode in accordance with embodiments of the present invention; and

FIG. 8 is an illustrative flowchart of methods for standard trading securities in a market making mode in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

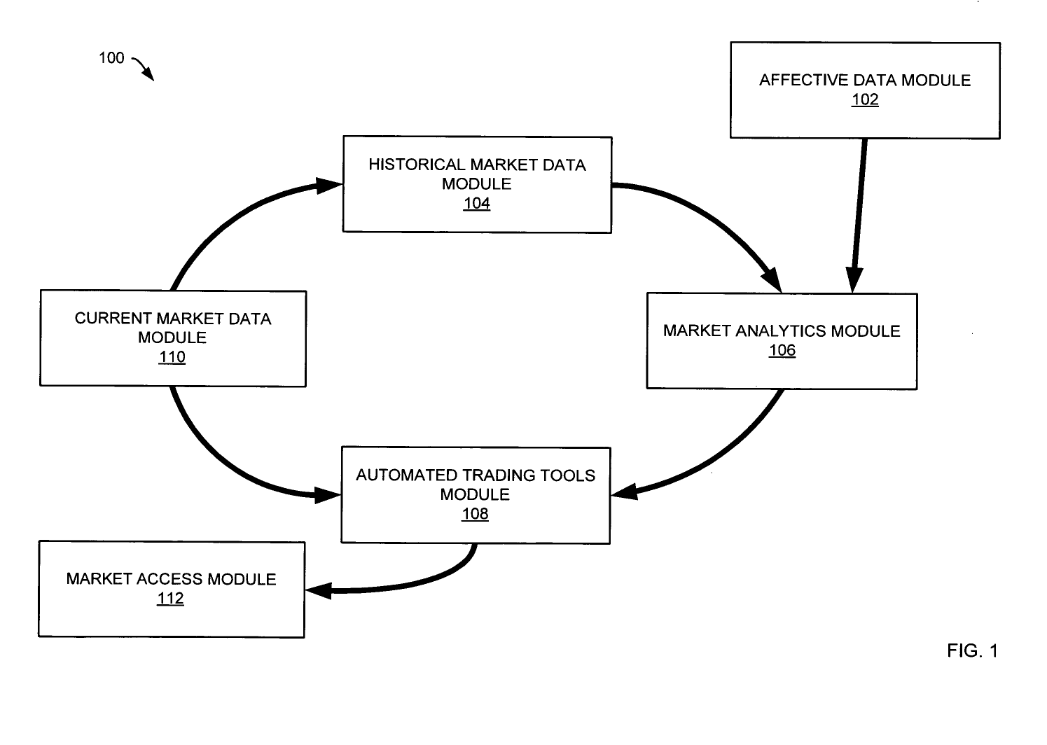

FIG. 1 is an illustrative representation of a securities trading system 100 in accordance with embodiments of the present invention. As illustrated, each module is representative of a functional component of the system. Thus, for example, historical market data module 104 may be configured for receiving historical market data related to a selected security or stock. In some embodiments, historical market data may include without limitation: historical security price, historical security index, historical price earnings, historical volume traded, historical first best buy and sell price, historical second best buy and sell price, historical third best buy and sell price, historical dividends, historical news analysis statistics, historical announcement analysis statistics, historical related securities, historical related indices, historical unrelated securities, and historical unrelated indices without departing from the present invention. As illustrated, historical market data module 104 supplies data for market analytics module 106. Affective data module 102 may be configured for receiving affective data related to a selected security or stock. In some embodiments, affective data may include without limitation: historical trends, volume trends, performance trends, and trends related to functional analyses of the historical market data without departing from the present invention. As illustrated, affective data module 102 supplies data for market analytics module 106.

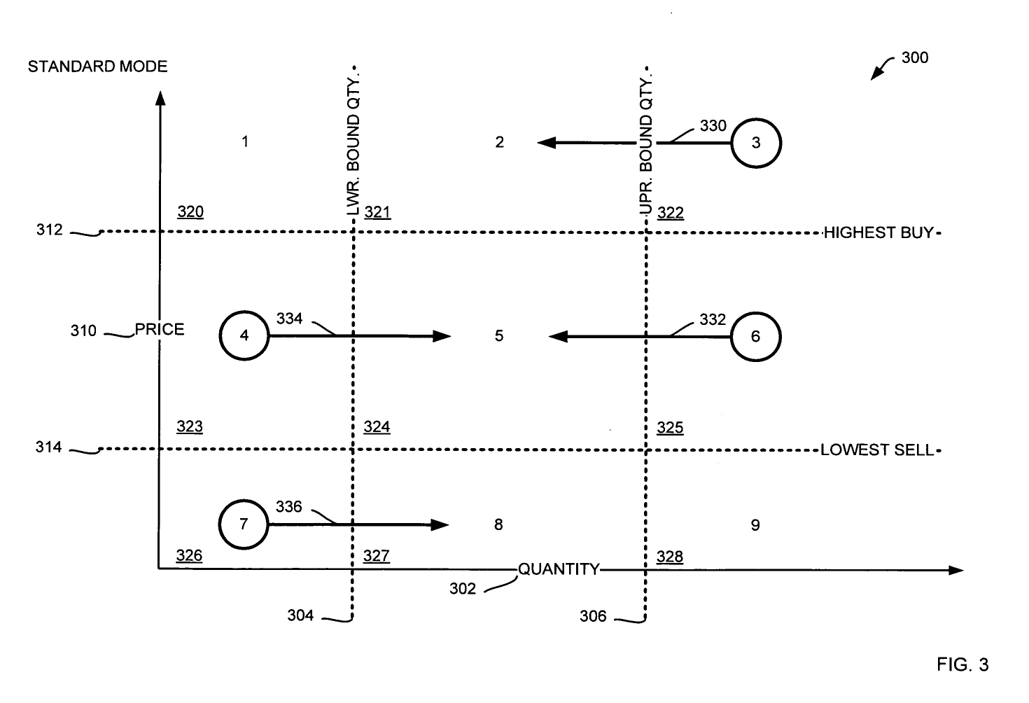

Market analytics module 106 may be configured for performing an analysis on historical market data and affective data to produce a set of causally related input parameters, which are sent to automated trading tools module 108. Causally related input parameters may be configured to provide a basis for determining whether to trade a selected security or stock. In some embodiments, analyses may include without limitation: portfolio holdings analysis, research report analysis, fundamental information analysis, global statistical analysis, and regional statistical analysis without departing from the present invention. Current market data module 110 may be configured for receiving current market data related to a selected security. In some embodiments, current market data may include without limitation: a current buy price, a current sell price, a last traded price, a regional order queue buy price for an individual exchange, a regional order queue sell price for an individual exchange, a global order queue buy price for an individual exchange, a global order queue sell price for an individual exchange, a previous-day close reference price, and a last traded volume without departing from the present invention. As illustrated, automated trading module 108 receives data from both market analytics module 106 and current market data module 110. Automated trading module 108 may be configured for automatically creating trade decisions for a selected security based on a set of causally related input parameters. Automated trading will be discussed in further detail below for FIGS. 3-8. Market access module 112 receives input from automated trading tools module 108 and may be configured for conveying trade decisions to a broker.

As may be appreciated, modules are linked to provide iterative data processing. That is, for example, historic market data and affective data may be initially analyzed by market analytics module to provide a starting point for an initial automated trading scenario. However, one advantage provided herein is that data used for market analysis is continually updated both with on-going current market data and with on-going affective data. In this manner, market fluctuations may be dynamically tracked so that changing conditions are not ignored by an initial automated trading scenario. In some embodiments, a user may update affective data on the fly to respond to seemingly unrelated market forces identified by the user. As such, systems provided herein may provide trading decisions that are more responsive to market fluctuation over conventional solutions.

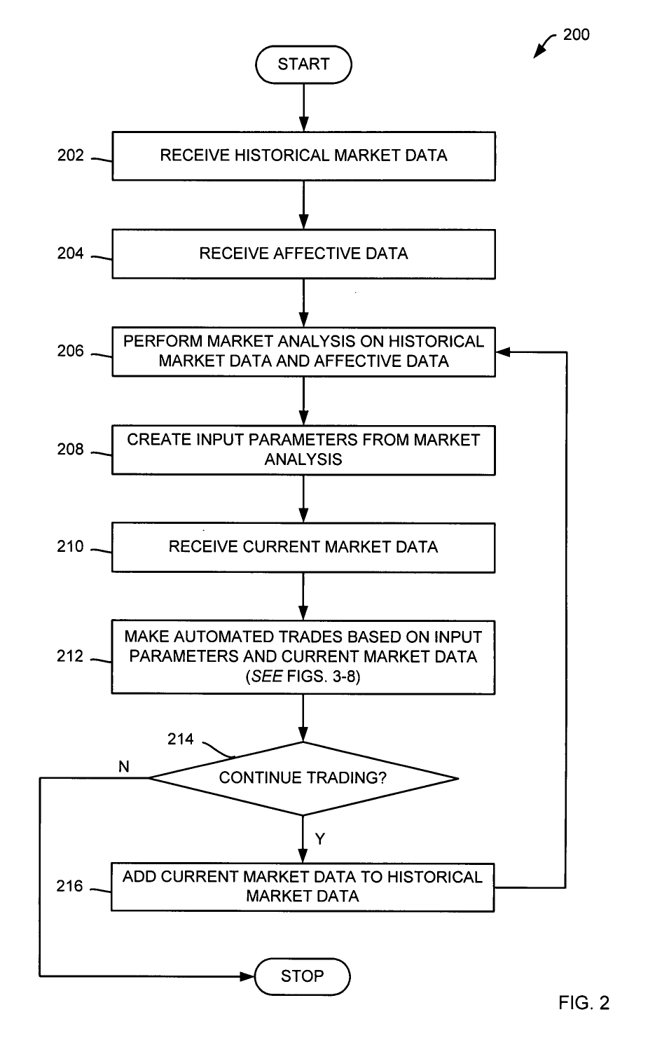

FIG. 2 is an illustrative flowchart 200 of methods for utilizing a securities trading system in accordance with embodiments of the present invention. At a first step 202, the method receives historical market data. Historical market data may be utilized by a market analytics module as described above as a basis for determining trends for a desired stock or security. Historical market data for analysis may be user selected or algorithmically selected and may include without limitation: historical security price, historical security index, historical price earnings, historical volume traded, historical first best buy and sell price, historical second best buy and sell price, historical third best buy and sell price, historical dividends, historical news analysis statistics, historical announcement analysis statistics, historical related securities, historical related indices, historical unrelated securities, and historical unrelated indices without departing from the present invention.

At a next step 204, the method receives affective data. Affective data is defined generally as user selected data that may be related, in some manner, to a particular security or stock. Affective data for analysis may be user selected or algorithmically selected and may include without limitation: historical trends, volume trends, performance trends, and trends related to functional analyses of the historical market data without departing from the present invention. At a next step 206, the method performs market analysis on historical market data and affective data. Any market analytic method may be utilized without limitation and without departing from the present invention. In some embodiments, analyses may include without limitation: portfolio holdings analysis, research report analysis, fundamental information analysis, global statistical analysis, and regional statistical analysis without departing from the present invention. At a next step 208, the method creates causally related input parameters from the market analysis. Causally related input parameters, in embodiments of the present invention may include without limitation: a lower bound quantity, an upper bound quantity, a highest buy price, and a lowest sell price. A lower bound quantity represents the lowest number of securities or shares desired for a given trading scenario. An upper bound quantity is the highest number of securities or shares desired for a given trading scenario. A highest buy price is the highest price a trading scenario will pay for a particular security or stock. A lowest sell price is the lowest price at which a trading scenario will sell a particular security or stock.

At a next step 210, the method receives current market data. Current market data may be utilized in coordination with market analytics to determine whether a trade is appropriate. Causally related input parameters, as described above, establish boundaries which, when utilized with current market data, determine a trade decision. In some embodiments, current market data may include: a current buy price, a current sell price, a last traded price, a regional order queue buy price for an individual exchange, a regional order queue sell price for an individual exchange, a global order queue buy price for an individual exchange, a global order queue sell price for an individual exchange, a previous-day close reference price, and a last traded volume. Current market data may be received or gathered in any manner well-known in the art without departing from the present invention. At a next step 212, the method makes automated trades based on causally related input parameters and current market data received. Embodiments of the present invention include several modes for automated trading including without limitation: a standard mode, a safe mode, and a market making mode. Modes for automated trading will be discussed in further detail below for FIG. 3-8.

At a next step 214, the method determines whether to continue trading. Determining whether to terminate trading may rely on trade termination conditions generated during market analysis or by user selection. In some embodiments, trade termination conditions include without limitation: a selected time interval, a target security held quantity, a number of trades per unit time limit, a total number of trades limit, an external triggering event, a market status event, a computational event derived from historical market data, a computational event derived from previous trading information, a market limit, user entered information based on historical market data, and a current time. If the method determines at a step 214 to continue trading, the method continues to a step 216 to add current market data to historical market data whereupon the method continues to a step 206. Current market data may be added to historical market data so that changing market conditions may be accounted for in market analytics. As may be appreciated, market analytics may be selected to target specific market conditions. When those conditions change, market analytics, to remain valid, must account for those changes. If the method determines at a step 214 to terminate trading, the method ends.

FIG. 3 is an illustrative representation of a graph 300 illustrating how causally related input parameters may be utilized for trading securities in a standard mode in accordance with embodiments of the present invention. In some embodiments, trading decisions may be determined by utilizing a price 310 over quantity 302 graph. As may be appreciated, trading decisions regarding any security or stock may be defined by price and quantity. As such, relative location on a price/quantity graph as illustrated may be utilized to drive trading decisions. As noted above, casually related input parameters may be generated from market analytics utilizing either historical market data or affective data or both. Casually related input parameters are illustrated here as lower bound quantity 304, upper bound quantity 306, highest buy price 312, and lowest sell price 314. These parameters form a matrix of nine regions 320 to 328. In a standard mode as illustrated here, trading decisions are driven by a desired quantity or quantity range of securities or stocks. Thus, as illustrated, desired quantities are represented by regions 2 (321), 5 (324), and 8 (327).

In general, when a held quantity is more or less than a desired quantity, then a trading decision must be made whether or not to buy or sell a security or stock. Thus, when a quantity held is greater than an upper bound quantity 306 and the current sell price is higher than the lowest sell price 314 as in regions 3 (322) and 6 (325), a sell decision may be made to attempt to reach regions 2 (321) and 5 (324) as indicated by arrows 330 and 332 respectively. Likewise, when a quantity held is less than a lower bound quantity 304 and the current buy price is lower than the highest buy price 312 as in regions 4 (323) and 7 (326), a buy decision may be made to attempt to reach regions 5 (324) and 8 (327) as indicated by arrows 334 and 336 respectively. Regions 1 (320) and 9 (328) fall outside of trade decisions for a given set of casually related input parameters and, as such, no trade will be made for securities or stocks in those regions. It may be appreciated that casually related input parameters, in embodiments described herein are not typically static boundaries. Rather, as market data is updates on a more or less continuous basis, those parameters may change in response to changes in market conditions.

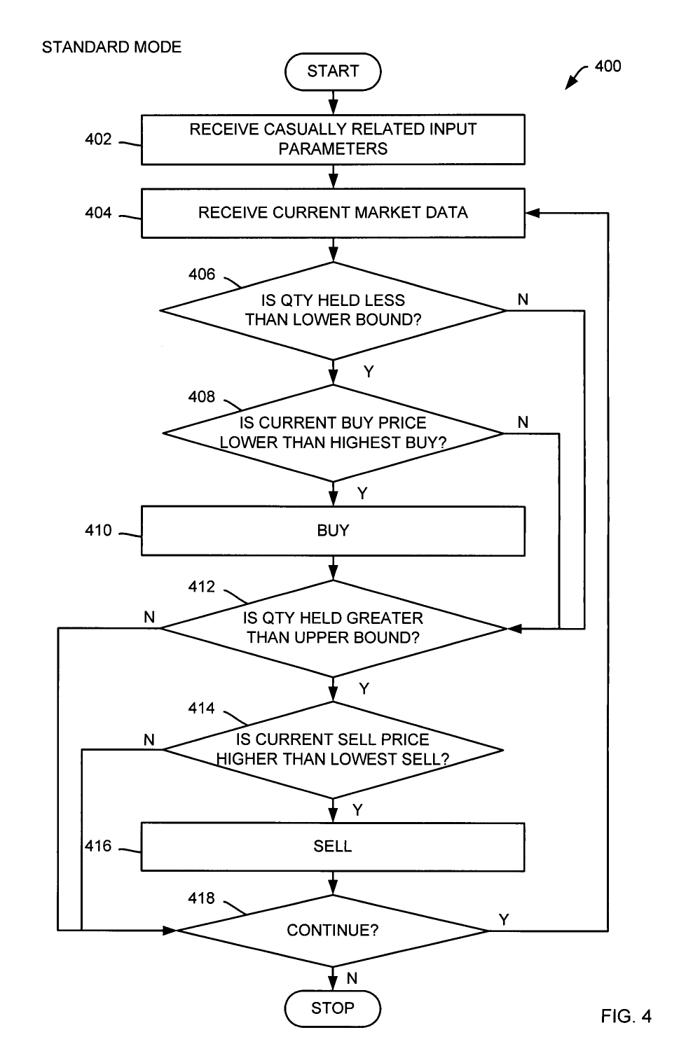

FIG. 4 is an illustrative flowchart 400 of methods for trading securities in a standard mode in accordance with embodiments of the present invention. At a first step 402, the method receives casually related input parameters. As noted above, casually related input parameters may be generated from market analytics utilizing either historical market data or affective data or both. Casually related input parameters include: a lower bound quantity, an upper bound quantity, a highest buy price, and a lowest sell price. At a next step 404, the method receives current market data. Current market data provides input for determining whether a buy or sell price is appropriate within a particular trading scenario context. Current market data may be gathered in any way known in the art without departing from the present invention. At a next step 406, the method determines whether a quantity of securities or stocks held is less than a lower bound quantity. Referring to FIG. 3, a yes determination at a step 406 is limited to returning any of regions 1 (320), 4 (323), and 7 (326). If the method determines at a step 406 that a quantity held is less than a lower bound quantity, the method continues to a step 408 to determine whether a current buy price is lower than a highest buy price. Referring to FIG. 3, a yes determination at a step 408 is limited to returning either of regions 4 (323) or 7 (336). If the method determines at a step 408 that a current buy price is lower than a highest buy price, the method continues to a step 410 to execute a buy trade. In embodiments herein, buy trades may include without limitation: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at volume weighted average price (VWAP) trade.

If the method determines at a step 406 that a quantity held is not less than a lower bound quantity, the method continues to a step 412. Further, if the method determines at a step 408 that a current buy price is not lower than a highest buy price, the method continues to a step 412. At a step 412, the method determines whether a quantity held is greater than an upper bound quantity. Referring to FIG. 3, a yes determination at a step 412 is limited to returning any of regions 3 (322), 6 (325), and 9 (328). If the method determines at a step 412 that a quantity held is greater than an upper bound quantity, the method continues to a step 414 to determine whether a current sell price is higher than a lowest sell price. Referring to FIG. 3, a yes determination at a step 414 is limited to returning either of regions 3 (322) or 6 (325). If the method determines at a step 414 that a current sell price is higher than a lowest sell price, the method continues to a step 416 to execute a sell trade. In embodiments herein, sell trades may include without limitation: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

If the method determines at a step 412 that a quantity held is not greater than an upper bound quantity, the method continues to a step 418. Further, if the method determines at a step 414 that a current sell price is not higher than a lowest sell price, the method continues to a step 418. At a next step 418, the method determines whether to continue. Determining whether to continue may depend, in some embodiments, upon a termination condition which may include without limitation: a selected time interval, a target security held quantity, a number of trades per unit time limit, a total number of trades limit, an external triggering event, a market status event, a computational event derived from historical market data, a computational event derived from previous trading information, a market limit, user entered information based on historical market data, and a current time. If the method determines at a step 418 to continue, the method returns to a step 404. If the method determines at a step 418 not to continue, the method ends.

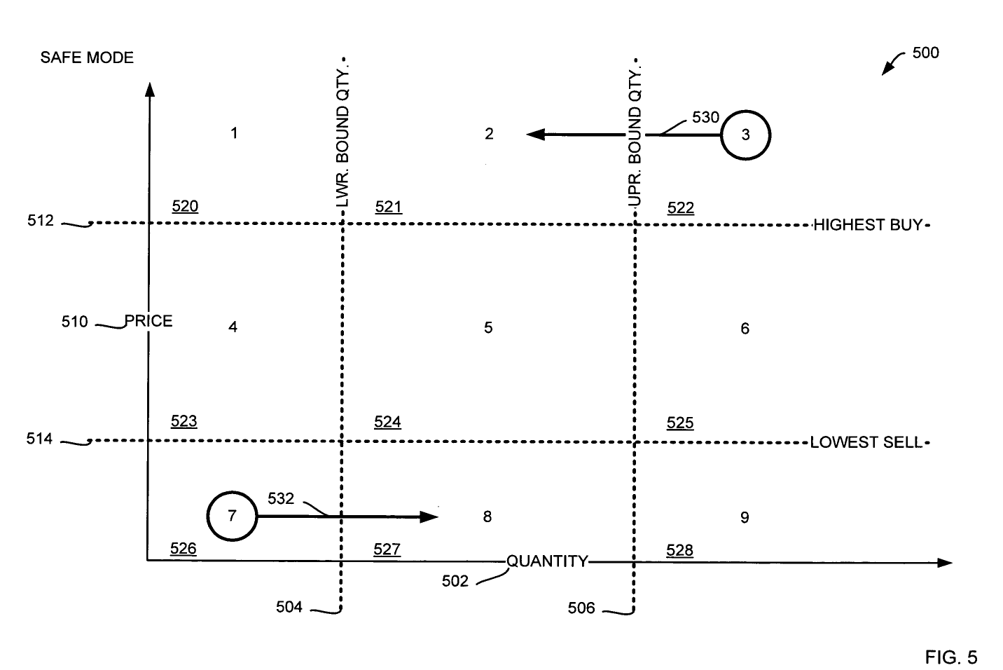

A standard mode provides for automated trading for prices that do not rapidly fluctuate. When trading prices fluctuate too rapidly, conditions may arise in which trades are being made which are continually losing. That is, buys may be made at too high of a price point and sells may be made at too low of a price point. For this reason, in some embodiments, a safe mode of operation may be utilized for rapidly fluctuating prices. In this way the upper and lower bound volumes can be brought together without concern allowing for easier model design. A mechanism to enforce the safe mode whenever the upper and lower bound volumes cross can also be used to simplify model designs. FIG. 5 is an illustrative representation of a graph 500 illustrating how causally related input parameters may be utilized for trading securities in a safe mode in accordance with embodiments of the present invention. In some embodiments, trading decisions may be determined by utilizing a price 510 over quantity 502 graph. As may be appreciated, trading decisions regarding any security or stock may be defined by price and quantity. As such, relative location on a price/quantity graph as illustrated may be utilized to determine trading decisions. As noted above, casually related input parameters may be generated from market analytics utilizing either historical market data or affective data or both. Casually related input parameters are illustrated here as lower bound quantity 504, upper bound quantity 506, highest buy price 512, and lowest sell price 514. These parameters form a matrix of nine regions 520 to 528. In a safe mode, as illustrated here, trading decisions are driven by a desired quantity or quantity range of securities or stocks. Thus, as illustrated, desired quantities are represented by regions 2 (521), 5 (524), and 8 (527) as above for FIG. 3.

In general, when a held quantity is more or less than a desired quantity, then a trading decision must be made whether or not to buy or sell a security or stock. Thus, when a quantity held is greater than an upper bound quantity 506 and a current sell price is higher than a highest buy price 512 as in region 3 (522), a sell decision may be made to attempt to reach region 2 (521) as indicated by arrow 530. In this embodiment, when prices fluctuate rapidly, a lowest sell price boundary may also fluctuate rapidly making trading decisions more volatile. In these embodiments, a built in “buffer” between a lowest sell price and a highest buy price as represented by region 6 (525) is maintained where no trades are made. In like manner, when a quantity held is less than a lower bound quantity 504 and a current buy price is lower than a lowest sell price 514 as in region 7 (526), a buy decision may be made to attempt to reach region 8 (527) as indicated by arrow 532. As above, in these embodiments, a built in “buffer” between a highest buy price and a lowest sell prices as represented by region 4 (523) is maintained where no trades are made. As such, a damping may be achieved by utilizing a buffer. In addition, regions 1 (520) and 9 (528) fall outside of buy and sell decisions for a given set of casually related input parameters and, as such, no trade will be made for securities or stocks in those regions. It may be appreciated that casually related input parameters, in embodiments described herein are not typically static boundaries. Rather, market data is updated on a more or less continuous basis, those parameters may change in response to changes in market conditions. In some embodiments, calculations are event driven, meaning that calculations occur whenever an input parameter changes. In this way, an effective sampling rate of over approximately 1000 samples per second is achieved. In some embodiments, a sampling rate of at least approximately 500 samples per second is achieved.

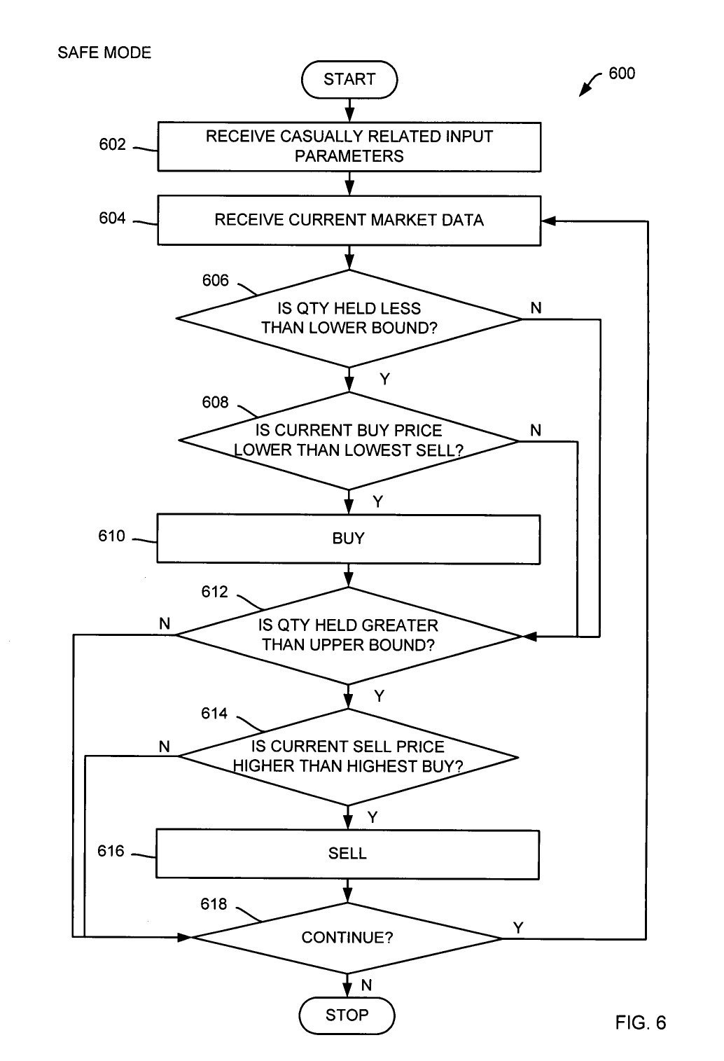

FIG. 6 is an illustrative flowchart 600 of methods for trading securities in a standard mode in accordance with embodiments of the present invention. At a first step 602, the method receives casually related input parameters. As noted above, casually related input parameters may be generated from market analytics utilizing either historical market data or affective data or both. Casually related input parameters include: a lower bound quantity, an upper bound quantity, a highest buy price, and a lowest sell price. At a next step 604, the method receives current market data. Current market data provides input for determining whether a buy or sell price is appropriate within a particular trading scenario context. Current market data may be gathered in any way known in the art without departing from the present invention. At a next step 606, the method determines whether a quantity of securities or stocks held is less than a lower bound quantity. Referring to FIG. 5, a yes determination at a step 606 is limited to returning any of regions 1 (520), 4 (523), and 7 (526). If the method determines at a step 606 that a quantity held is less than a lower bound quantity, the method continues to a step 608 to determine whether a current buy price is lower than a lowest sell price. Referring to FIG. 5, a yes determination at a step 608 is limited to returning region 7 (536). If the method determines at a step 608 that a current buy price is lower than a lowest sell price, the method continues to a step 610 to execute a buy trade. In embodiments herein, buy trades may include without limitation: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at VWAP trade.

If the method determines at a step 606 that a quantity held is not less than a lower bound quantity, the method continues to a step 612. Further, if the method determines at a step 608 that a current buy price is not lower than a lowest sell price, the method continues to a step 612. At a step 612, the method determines whether a quantity held is greater than an upper bound quantity. Referring to FIG. 5, a yes determination at a step 612 is limited to returning any of regions 3 (522), 6 (525), and 9 (528). If the method determines at a step 612 that a quantity held is greater than an upper bound quantity, the method continues to a step 614 to determine whether a current sell price is higher than a highest buy price. Referring to FIG. 5, a yes determination at a step 614 is limited to returning region 3 (522). If the method determines at a step 614 that a current sell price is higher than a highest buy price, the method continues to a step 616 to execute a sell trade. In embodiments herein, sell trades may include without limitation: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

If the method determines at a step 612 that a quantity held is not greater than an upper bound quantity, the method continues to a step 618. Further, if the method determines at a step 614 that a current sell price is not higher than a highest buy price, the method continues to a step 618. At a next step 618, the method determines whether to continue. Determining whether to continue may depend, in some embodiments, upon a termination condition which may include without limitation: a selected time interval, a target security held quantity, a number of trades per unit time limit, a total number of trades limit, an external triggering event, a market status event, a computational event derived from historical market data, a computational event derived from previous trading information, a market limit, user entered information based on historical market data, and a current time. If the method determines at a step 618 to continue, the method returns to a step 604. If the method determines at a step 618 not to continue, the method ends.

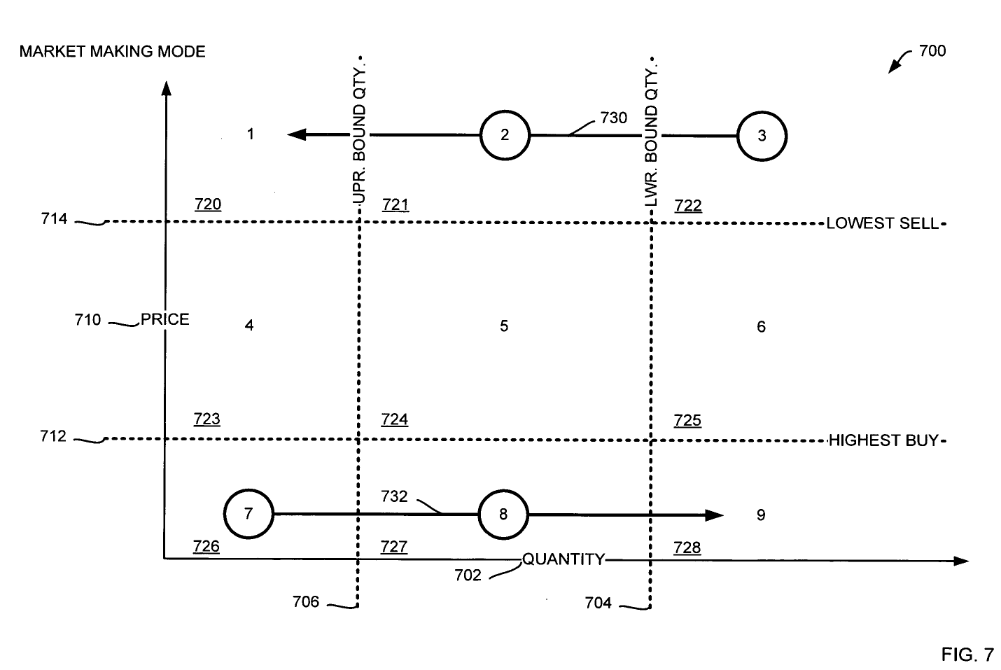

In some embodiments, it may be desirable to drive trading decisions to quantities outside of a desired range. FIG. 7 is an illustrative representation of a graph 700 illustrating how causally related input parameters may be utilized for trading securities in a market making mode in accordance with embodiments of the present invention. In some embodiments, trading decisions may be determined by utilizing a price 710 over quantity 702 graph. As may be appreciated, trading decisions regarding any security or stock may be defined by price and quantity. As such, relative location on a price/quantity graph as illustrated may be utilized to determine trading decisions. As noted above, casually related input parameters may be generated from market analytics utilizing either historical market data or affective data or both. Casually related input parameters are illustrated here as lower bound quantity 704, upper bound quantity 706, highest buy price 712, and lowest sell price 714. It may be noted that casually related input parameters as illustrated here are reversed with respect to order as in FIGS. 3 and 5. Reversing order of parameters may provide additional trading advantages. In the case of FIG. 7, buy orders are traded at lower prices than sell orders, while the engine is maximizing the quantities of buy and sell within predetermined safe limits set by the user, maximizing profits of each trade. These parameters form a matrix of nine regions 720 to 728. In a market making mode as illustrated here, trading decisions are driven outside a desired quantity or quantity range of securities or stocks. Thus, as illustrated, desired quantities are represented by regions 1 (720) and 9 (728).

Thus, when a quantity held is greater than an upper bound quantity 706 and a current sell price is higher than a lowest sell price 714 as in regions 2 (721) and 3 (722), a sell decision may be made to attempt to reach region 1 (720) as indicated by arrow 730. In like manner, when a quantity held is less than a lower bound quantity 704 and a current buy price is lower than a highest buy price (712) as in regions 7 (726) and 8 (727), a buy decision may be made to attempt to reach region 9 (728) as indicated by arrow 732. It may be appreciated that casually related input parameters, in embodiments described herein are not typically static boundaries. Rather, as market data is updates on a more or less continuous basis, those parameters may change in response to changes in market conditions.

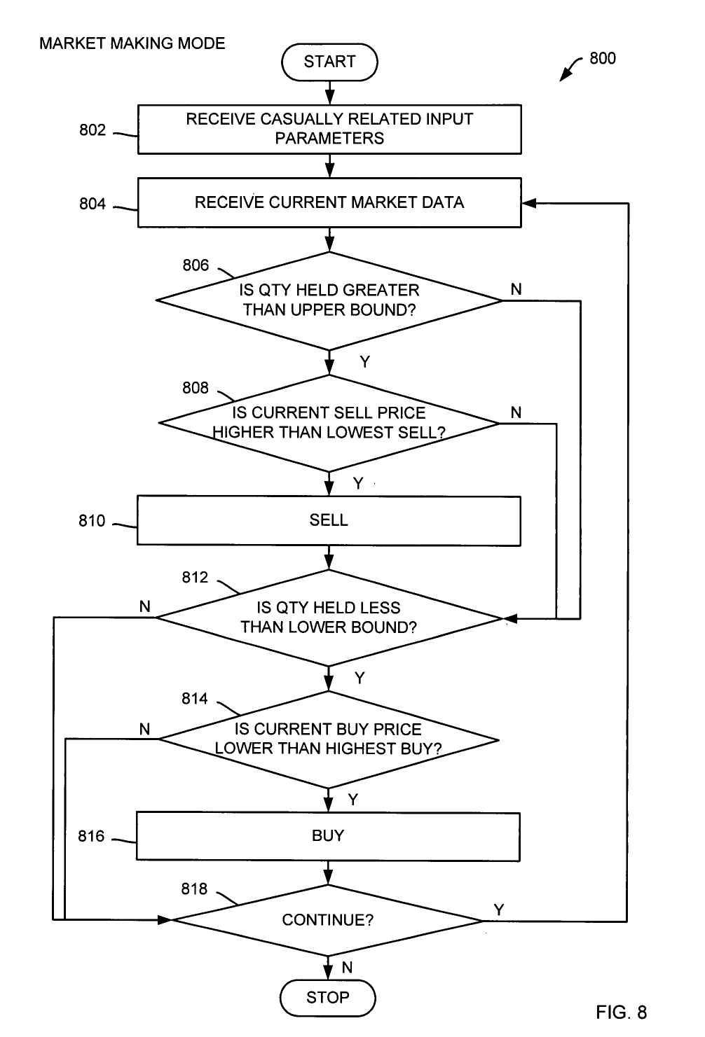

FIG. 8 is an illustrative flowchart 800 of methods for trading securities in a market making mode in accordance with embodiments of the present invention. At a first step 802, the method receives casually related input parameters. As noted above, casually related input parameters may be generated from market analytics utilizing either historical market data or affective data or both. Casually related input parameters include: a lower bound quantity, an upper bound quantity, a highest buy price, and a lowest sell price. At a next step 804, the method receives current market data. Current market data provides input for determining whether a buy or sell price is appropriate within a particular trading scenario context. Current market data may be gathered in any way known in the art without departing from the present invention. At a next step 806, the method determines whether a quantity of securities or stocks held is greater than an upper bound quantity. Referring to FIG. 7, a yes determination at a step 806 is limited to returning any of regions 2 (721), 3 (722), 5 (724), 6 (725), 8 (727), and 9 (728). If the method determines at a step 806 that a quantity held is greater than an upper bound quantity, the method continues to a step 808 to determine whether a current sell price is higher than a lowest sell price. Referring to FIG. 7, a yes determination at a step 808 is limited to returning regions 2 (721) and 3 (722). If the method determines at a step 808 that a current sell price is higher than a lowest sell price, the method continues to a step 810 to execute a sell trade. In embodiments herein, sell trades may include without limitation: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

If the method determines at a step 806 that a quantity held is not greater than an upper bound quantity, the method continues to a step 812. Further, if the method determines at a step 808 that a current sell price is not higher than a lowest sell price, the method continues to a step 812. At a next step 812, the method determines whether a quantity held is less than a lower bound quantity. Referring to FIG. 7, a yes determination at a step 812 is limited to returning any of regions 1 (720), 2 (730), 4 (723), 5 (724), 7 (726), and 8 (727). If the method determines at a step 812 that a quantity held is less than a lower bound quantity, the method continues to a step 814 to determine whether a current buy price is lower than a highest buy price. Referring to FIG. 7, a yes determination at a step 814 is limited to returning regions 7 (726) and 8 (727). If the method determines at a step 814 that a current buy price is lower than a highest buy price, the method continues to a step 816 to execute a buy trade. In embodiments herein, buy trades may include without limitation: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at VWAP trade.

If the method determines at a step 812 that a quantity held is not less than a lower bound quantity, the method continues to a step 818. Further, if the method determines at a step 814 that a current buy price is not lower than a highest buy price, the method continues to a step 818. At a next step 818, the method determines whether to continue. Determining whether to continue may depend, in some embodiments, upon a termination condition which may include without limitation: a selected time interval, a target security held quantity, a number of trades per unit time limit, a total number of trades limit, an external triggering event, a market status event, a computational event derived from historical market data, a computational event derived from previous trading information, a market limit, user entered information based on historical market data, and a current time. If the method determines at a step 818 to continue, the method returns to a step 804. If the method determines at a step 818 not to continue, the method ends.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for making real-time automated security trades, the method comprising:
receiving historical market data related to a selected security;
receiving affective data related to the selected security;
performing an analysis on the historical market data and the affective data to produce a set of causally related input parameters, the set of causally related input parameters configured to provide a basis for determining whether to trade the selected security;
receiving current market data related to the selected security;
applying the current market data to the set of causally related input parameters; and
automatically trading the selected security based on the applying.

2. The method of claim 1 further comprising:
incorporating the current market data with the historical market data; and
returning to the performing the analysis.

3. The method of claim 2, wherein the incorporating the current market data with the historical market data is event driven at a sampling rate of at least 500 samples per second.

4. The method of 1 wherein the historical market data is selected from the group consisting of: historical security price, historical security index, historical price earnings, historical volume traded, historical first best buy and sell price, historical second best buy and sell price, historical third best buy and sell price, historical dividends, historical news analysis statistics, historical announcement analysis statistics, historical related securities, historical related indices, historical unrelated securities, and historical unrelated indices.

5. The method of claim 1 wherein the affective data is selected from the group consisting of: historical trends, volume trends, performance trends, and trends related to functional analyses of the historical market data.

6. The method of claim 1 wherein the analysis is selected form the group consisting of: portfolio holdings analysis, research report analysis, fundamental information analysis, global statistical analysis, and regional statistical analysis.

7. The method of claim 1 wherein the set of casually related input parameters include:
a lower bound quantity;
an upper bound quantity;
a highest buy price; and
a lowest sell price.

8. The method of claim 7 wherein the current market data is selected from the group consisting of: a current buy price, a current sell price, a last traded price, a regional order queue buy price for an individual exchange, a regional order queue sell price for an individual exchange, a global order queue buy price for an individual exchange, a global order queue sell price for an individual exchange, a previous-day close reference price, and a last traded volume.

9. The method of claim 8 wherein the automatically trading the selected security includes:
determining whether a quantity held is less than the lower bound quantity;
if the quantity held is less than the lower bound quantity,
determining whether the current buy price is lower than the highest buy price;
if the current buy price is lower than the highest buy price, executing a buy trade;
else determining whether the quantity held is greater than the upper bound quantity;
if the quantity held is greater than the upper bound quantity,
determining whether the current sell price is higher than the lowest sell price; and
if the current sell price is higher than the lowest sell price, executing a sell trade.

10. The method of claim 9 wherein the buy trade is selected from the group consisting of: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at volume weighted average price (VWAP) trade.

11. The method of claim 9 wherein the sell trade is selected from the group consisting of: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

12. The method of claim 8 wherein the automatically trading the selected security includes:
determining whether a quantity held is less than the lower bound quantity;
if the quantity held is less than the lower bound quantity,
determining whether the current buy price is lower than the lowest sell price;
if the current buy price is lower than the lowest sell price, executing a buy trade;
else determining whether the quantity held is greater than the upper bound quantity;
if the quantity held is greater than the upper bound quantity,
determining whether the current sell price is higher than the highest buy price; and
if the current sell price is higher than the highest buy price, executing a sell trade.

13. The method of claim 12 wherein the buy trade is selected from the group consisting of: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at VWAP trade.

14. The method of claim 12 wherein the sell trade is selected from the group consisting of:
a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade

15. The method of claim 8 wherein the automatically trading the selected security includes:
determining whether a quantity held is greater than the upper bound quantity;
if the quantity held is greater than the upper bound quantity,
determining whether the current sell price is higher than the lowest sell price;
if the current sell price is higher than the lowest sell price, executing a sell trade;
else determining whether the quantity held is less than the lower bound quantity;
if the quantity held is less than the lower bound quantity,
determining whether the current buy price is lower than the highest buy price; and
if the current buy price is lower than the highest buy price, executing a buy trade, wherein the upper bound quantity is inverted with respect to the lower bound quantity and the highest buy price is inverted with respect to the lowest sell price.

16. The method of claim 15 wherein the buy trade is selected from the group consisting of: a buy trade, a buy call trade, a buy put trade, a buy limit order, a buy stop loss trade, a buy to cover trade, a buy on a targeted exchange, a buy on any exchange, a cash order buy trade, a margin order buy trade, a buy fill trade, a buy kill trade, a buy limit price trade, a buy market order trade, a peg to bid trade, a peg to ask trade, a peg to midpoint trade, and a buy at VWAP trade.

17. The method of claim 15 wherein the sell trade is selected from the group consisting of: a sell trade, a sell call trade, a sell put trade, a sell limit order, a sell stop loss trade, a sell to cover trade, a sell on a targeted exchange, a sell on any exchange, a cash order sell trade, a margin order sell trade, a sell fill trade, a sell kill trade, a sell limit price trade, a sell market order trade, a peg to bid trade, a peg to ask trade, a peg to midpoint trade, and a sell at VWAP trade.

18. The method of claim 2 further comprising:
before the incorporating the current market data, determining whether to continue trading based on a trade termination condition.

19. The method of claim 18 wherein the trade termination condition is selected from the group consisting of: a selected time interval, a target security quantity held, a number of trades per unit time limit, a total number of trades limit, an external triggering event, a market status event, a computational event derived from historical market data, a computational event derived from previous trading information, a market limit, user entered information based on historical market data, and a current time.

20. A system for making real-time automated security trades, the system comprising:
a historical market data module configured for receiving historical market data related to a selected security;
an affective data module configured for receiving affective data related to the selected security;
a market analytics module configured for performing an analysis on the historical market data and the affective data to produce a set of causally related input parameters, the set of causally related input parameters configured to provide a basis for determining whether to trade the selected security;
a current market data module configured for receiving current market data related to the selected security; and
an automated trading module configured for automatically creating a plurality of trade decisions for the selected security based on the set of causally related input parameters; and
a market access module for conveying the plurality of trade decisions to a securities broker.

21. The system of claim 20 wherein the analytics module is further configured to apply the current market data to the set of causally related input parameters and to incorporate the current market data with the historical market data.
